(19) United States
(12) Patent Application Publication
(10) Pub. No.: US 2005/0097810 A1
(43) Pub. Date: May 12, 2005

(54) Rodent bait package formed from cellulose film

(76) Inventor: Linton Drew Staples, Victoria (AU)

Correspondence Address: Leopold Presser;Scully Scott Murphy & Presser, 400 Garden City Plaza, Garden City, NY, 11530, US

(21) Appl. No.: 10/399,592

(22) PCT Filed: Oct. 19, 2001
(86) PCT No.: PCT/AU01/01345

(30) Foreign Application Priority Data
Oct. 20, 2000 (AU) PR 0923

(51) Int. Cl. A01M 1/20; A01M 25/00

(52) U.S. Cl. 43/131

(57) ABSTRACT

A bait package comprising an enclosure or sachet containing bait, said enclosure formed from a cellulose film, cellophane or cellulose film modified by gamma radiation. the bait is protected from the environmental factors for a time sufficient for it to serve its purpose, yet allows degradation of the package in an environmentally acceptable way. The bait comprises a palatable and edible carrier in association with an active agent that affects the physiology of the target pest. The edible carrier can be cereal, seed, fruit, nut, dairy or food products in a pelleted or granular form. The active agent is selected from hormones, vaccines, metal phosphides such as zinc, magnesium or aluminium phosphide, anticoagulants such as coumerin and indole classes and toxic chemicals such as 1080 and strychnine.

This invention relates to baits, especially baits for eradicating mice, rats or rabbits. In particular the invention relates to a package which is capable of delivering a bait to an area which is exposed to the environment, such that the bait is protected from the environmental factors for a time sufficient for it to serve its purpose, yet allows degradation of the package in an environmentally acceptable way.

The delivery of baits to areas exposed to environmental factors is a significant problem, especially when the area to be baited is a crop which is to be later harvested. Conventional plastic or polypropylene bait packages which have been used in the past, while protecting the bait from environmental degradation, remain undegraded in the area of the crop when the crop is harvested. This can result in contamination of the harvested crop. Even if the plastic material is not collected with the crop during harvesting, it still remains in the environment after the bait is taken causing environmental pollution Paper packages degrade in the environment but do not provide protection of the bait from the conditions that may cause the bait materials to degrade. The issues are special problems in wet, humid and warm tropical conditions but also arise from time to time in most crops in which control of pest animals is required.

Most baits for mice, rats and rabbits are in the form granules, dusts or cracked grain. Where it is necessary to apply the bait to large areas it is often necessary to apply the bait using seed spreaders or aircraft via aircraft hoppers. The broad-acre application method works adequately when it is desired to remove small animals such as mice that require exposure to only small quantities of bait material that can be applied as discrete granules or grains. The problem with this method of application is that while this achieves good dispersal of the bait, it does not provide sufficient concentration of bait to kill larger pests, such as rats. It is a special problem for baits that contain acute or short acting poisons since it is desirable to apply the product in such a way that a target animal obtains access to a lethal dose as quickly as possible. This minimises the risk of the development of a learned aversion that may arise From repeated sub-lethal exposures. Accordingly it would be convenient to provide a bait package which is capable of providing concentrations of bait sufficient to kill larger pests in a form which does not contaminate harvested crops or cause environmental pollution.

Accordingly in a first aspect the present invention provides a package comprising an enclosure containing a bait, said enclosure being formed from a cellulose or modified cellulose film.

In another aspect the invention provides a method for delivering a bait to an area exposed to the environment which method comprises dispersing throughout said area packages comprising an enclosure containing a bait, said enclosure being formed from a cellulose or modified cellulose film.

The term “bait” as used herein refers to a pest control agent which is palatable and at least partially edible by a target pest, and which is associated with an active agent which affects the physiology of the target pest. Generally the bait will comprise a palatable and edible carrier in association with an active agent. The active agent may be any suitable agent which affects the physiology of the target pest in a desired manner. For example the active agent may be a compound or composition capable of affecting reproductive performance of the target pest. For example the active agent may contain or consist of a hormone or hormone antagonist. The active agent may also be a vaccine. For example the active agent may be a vaccine against foot and mouth disease, which would be particularly useful in the case of wild pigs, or a vaccine against rabies in the case of wild dogs. The active agent may be a metal phosphide, such as zinc, magnesium or aluminium phosphides. These phosphides, particularly zinc phosphide, are useful when the target pests are rodents. The active agent may also be an anticoagulant which interferes with the blood clotting ability of the target pest. Examples of such anticoagulants include those of the coumerin class, such as warfrarin, coumatetralyl, bromadiolone and brodifacoum, and those of the indole class, such as pindone, chlorophacinone and diphacinone. Other active agents include toxic chemicals, such as fluoroacetic acid, also known as 1080 and strychnine. The terms “active agent” and “poison” are used interchangeably throughout this specification. The active agent may be a mixture of two or more active agents.

The palatable and edible carrier will generally contain or consist of a substance which is a food source for the target pest. The carrier may be a cereal product, such as a ground meal, whole or cracked grain, cereal dusts, seed head or the like, or other seed product, such as legumes, sunflower seeds, grass seeds etc. In a preferred embodiment the carrier is a sterilised whole grain product, such as wheat or oats. The carrier may be a fruit or nut product, such as dried apples or shelled peanuts, a dairy product, such as cheese, or may be a pelleted or granular product, such as animal or poultry food pellets or the like. The carrier may also comprise a cellulose material, such as sawdust, which has been impregnated with an edible substance, such as an oil. The carrier may further include attractants, such as flavourants, or scented substances. The attractant may be a natural or artificial essence, such as banana, aniseed or chocolate. The bait may also contain other additives, known to the art, such as colourants, preservatives and the like.

The active agent may be associated with the palatable and edible carrier in any manner known to the art. For example, a water soluble active agent or a lipid soluble agent may be dissolved in water or an appropriate organic solvent and sprayed on the carrier which is then subjected to a drying step. In the case of granules and pellets, the active agent may be incorporated in the composition prior to or during the granulation or pelletisation processes. The active ingredient may be a dry powder that is dispersed into a carrier or binding solution and then dispersed throughout the palatable carrier by any appropriate mixing, tumbling or spraying technique common in the art.

The term “cellulose or modified cellulose film” as used herein refers to a thermoplastic film composed of cellulose or cellulose which has been modified to alter its properties. The films of the present invention, which generally have a thickness of between 0.01 and 0.25 mm, are to be contrasted with the cellulosic materials, such as paper and cardboard. Methods of modifying cellulose to alter its biodegradability have been described in the prior art, for example Australian Patent Application No. 52513/93. Cellulose films/membranes which are commercially produced are supplied in a range of thicknesses that provide varying levels of mechanical protection of the contents and that degrade at different rates, the thinner the membrane the lower the strength of the packaging and the faster it is likely to degrade under the influence of ultra violet radiation in sunlight, water and/or the action of microbes in the soil or environment. When poisonous baits are used to provide control of a rodent it is often desirable that the bait material is protected from the influx of moisture for a period sufficient to achieve the desired purpose but then for both the packaging and the poisonous contents of the packaging to degrade in the environment. This may be achieved by selecting membranes of different thickness for different requirements. It may also be achieved by altering the nature of the membrane material itself. It has now been surprisingly found that the water absorbtion and water permeability properties of cellulose may be altered by subjecting the cellulose (or modified cellulose) film to gamma radiation. This method represents a further aspect of the invention, although such modified cellulose films may find application outside the field of baits, for example in the production of capsules for pharmaceutical or veterinary products. According to this aspect of the invention there is provided a method for increasing the water permeability and/or the water absorbtion of a cellulose or modified cellulose film comprising subjecting said film to a source of gamma radiation. The amount of radiation will depend on the type of cellulose film and the degree of water absorbtivity or permeability which is desired. Generally the amount of radiation will be in the range of 5 to 100, more preferably 30 to 50, kilograys. The source of gamma radiation is preferably ⁶⁰Co but could be from any method of producing radiation including x-ray tubes and other isotopic sources of suitable radiation. The rate at which moisture enters the package can be influenced by the irradiation treatment and thus the lifespan of the package and the contents of the package can be controlled to suite any requirement. The cellulose film may be subjected to radiation in the form of a roll or sheet prior to formation of the enclosure, or may be irradiated after packaging of the bait. In the latter case the radiation can act to sterilise the bait. Preferably the film is irradiated prior to construction of the finished package.

The package according to the invention is particularly suitable for use with baits which are sensitive to environmental factors, such as water or sunlight and which require a suitable degree of mechanical protection during storage, transport and application processes. In this regard while many types of flim such as plastic films and particularly those made from plastics such as polypropylene or polyethylene may be altered in their properties by exposure to radiation, the resultant effect may be to simultaneously increase both the permeability of the film and to substantially decrease the structural integrity of the film. A significant loss of structural integrity may not be desirable if it destroys the ability of the membrane to adequately contain the bait material or components of the bait material. An example of an active poison which is sensitive to moisture is zinc phosphide, Zn₃P₂. This active ingredient reacts which acids to produce phosphine and zinc ions. Rain water is capable of dissolving carbon dioxide, thereby producing carbonic acid. Such carbonic acid can degrade zinc phosphide. Zinc phosphide can also be degraded in the presence of moisture to form phosphates and can react with water that contains dissolved substances and minerals from the soil.

The package according to the invention is also particularly suitable for use with water-soluble agents, such as water-soluble anticoagulant agents or other water soluble poisons. An example of such an agent is fluoroacetic acid, also known as 1080. The invention is also useful for use with pelleted baits, including those manufactured to include binding agents that are soluble in water or constructed from materials such as pollard or crushed grain that expand in water, which therefore need to be protected from environmental factors, particularly in wet areas or in tropical conditions.

The use of cellulose or modified cellulose as a material for the package film provides a number of surprising advantages. Once such advantage is that when the package is opened up by the target animal it becomes brittle and falls apart. This means that the package cannot be taken far by the target animal. While in some cases the bait will be eaten at the site where the package is deposited, in some instances the package will be carried short distances by the target animal to its burrow or nest. This can result in extermination of all or a majority of the target animals at that particular nest or burrow site. When zinc phosphide is used as a bait for rats, it is common for the zinc phosphide bait to be carried back to the rat's nest where the bait may come into contact with urine from the rat to cause the bait to release phosphine gas which can kill other target animals within the nest or which may provide a localised source of bait to be eaten by other animals within the nest.

Another advantage of using cellulose film, or cellophane, or modified cellulose is that it only acts to protect the bait for a short period of time. This period of time may be as low as two to three weeks in high rainfall areas or where there is strong sunlight falling upon the bait package. Once the package degrades the bait is exposed to the environment such that it also degrades. This overcomes the problems associated with the use of other plastic sachets which take significantly longer periods to degrade. The fact that the duration of baiting is limited provides significant environmental advantages.

A further advantage of cellulose film is that it can accept printing. The packages or sachets can be printed in away which provides warnings about the nature and uses of the contents, or which camouflages the bait from non-target animals and birds, thereby providing more effective targeting of control to the target organisms. When the packages are camouflaged it is also possible to leave transparent windows through which the bait can be seen by the target animals. A further advantage of cellulose film is that odours can pass through it such that even when the package is completely opaque, the bait can still be detected by target animals.

The size of the package or sachet will depend on the particular target organism. Similarly the packages may contain any suitable quantity of bait, the amount of which will generally be in the range of 1 to 100 grams, preferably 5 to 50 grams, depending on the nature of the bait and the concentration of the active agent. As mentioned above, in addition to the active agent the bait may also include other additives known to the art, such as colorants, attractants, such as scents or flavourants.

The bait contained within the sachet is preferably granular. It may be in the form of pellets or it may be in the form of cracked or whole grains which have been treated with an active poison. In the case of grain or whole grains it is preferable that they are sterilised to avoid environmental contamination. However, the bait material may also be a liquid, a slurry or a solid or semi solid formulation such as paste or a waxy block.

A further advantage in the use of the packages according to the present invention is that they provide safer handling. The packages or sachets may be applied by any convenient means, for example by hand casting while driving through or around a clop. The spacing of the packages will depend on the concentration of the active agent and the nature of the target animal. A further advantage of the use of cellulose in the context of this invention is that sachets and packages can be conveniently heat sealed to contain the bait. The packages may also be provided in a dispenser, bait station or container which restricts access to the sachets by non-target animals or people while allowing access by the target animal.

For particular situations it may be necessary to modify the cellulose film of the package so as to provide particular degradation characteristics. Such methods would be well known to a person skilled in the modification of cellulose.

The packages of the present invention are especially suitable for use in sugar cane crops. Rats of two species (Rattus sordidus and Melomys burtoni) infest sugar cane crops in Australia and cause significant damage to cane stalks to reduce harvested yield and sugar content in the affected crop. Each of these rats may require from 2 to 5 cereal grains, containing a poison such as zinc phosphide at a final concentration of 2.5% w/w, for the intake of an LD₅₀ acute dose of poison. Since rats are known to develop aversion to sub-lethal quantities of zinc phosphide over several exposures, it is appropriate to apply bait as small, localised aggregates rather than by spreading poisonous bait materials evenly over wide areas. This provides localised concentrations of bait sufficient to provide a lethal dose at the first encounter of the bait package by the rat. Similar considerations apply to the problems of infestation of sugarcane or other crops and plantations with many different species of rodent.

This approach requires lower rates of application of chemical poison than is required if the bait is distributed evenly throughout the treated area. In the latter case much higher total application rates are required to achieve a high density of bait in an area where a rodent may be foraging so that the rodent quickly finds and consumes a lethal dose before sensing that the poison may be dangerous. Application of high rates of bait is an approach taken in other countries where rates of up to 10 kg of bait per hectare are applied compared to just 1 kg/ha in Australia for rat control. Another alternative would be to apply the bait as a trail, but this would be labour intensive and would also be likely to require higher total application rates than required using the packages of the present invention. Moreover, trail baiting in well-grown crops would not be possible due to difficulties of access.

It was considered desirable in the sugar cane growing industry to develop a method of presentation of bait that achieved sufficient localisation of bait to control rats while limiting the total quantity of bait supplied per hectare. Also, in the wet tropical conditions such as where sugar cane is grown, there is a need to provide some protection of the bait against the wet conditions within the crop, while at the same time providing for the bait to be degraded over time so that long-term contamination of the environment with poisonous materials is avoided. This combination of protection and then gradual degradation is desired since the preferred active ingredient, zinc phosphide, degrades once in the presence of water into which may dissolve carbon dioxide from the atmosphere. The resultant solution of weak carbonic acid provides hydgrogen ions (H⁺) to drive the degradation of the poison according to the following general equation:
Zn₃P₂+6H⁺→2PH₃+3Zn⁺⁺

The present invention provides the advantages of localisation of lethal quantities of bait, temporary protection against moisture, and eventual degradation of the bait in the crop environment. The use of a disposable (non-recoverable) bait container for the delivery of an acute poison also overcomes the requirement for repeated handling of bait dispensers by landowners such as is required by the use of multiple dose anticoagulant poisons and this minimises the risk of exposure to disease such as leptospirosis which may contaminate bait stations visited by rats. Moreover the use of a degradable package reduces the likelihood of exposure of the farmer to the bait material during handling or placement of the bait.

In order to further describe the invention reference will be made to the following examples which illustrate some preferred aspects of the invention. It should be noted that the following description of the invention is not to supersede the generality of the preceding description of the invention.

### EXAMPLES

### Example 1

Sachets where prepared using 25 grams of oats or wheats which have been treated with zinc phosphide. The cellulose film had a thickness of 0044 mm and a density of approximately 27 grams per square meter of film and the sachets were of a size of 50×80×5 millimetres. The sachets were prepared by folding a flat film into a tube then sealing along the join by the application of heat to the overlapping edges at the junction. The tube was then heat sealed at one end to form a pocket that was then filled to the desired level or weight with the grain and sealed off at the other end to form a complete packet. This may was done manually, although commercially it would be achieved by automated equipment that is well known and commercially available.

### Example 2

Sachets were made containing 10 grams of oats or wheat which have been treated with zinc phosphide. The cellulose film had a thickness of 0.044 mm and the sachets were of a size of 55×55×5 millimetres. The sachets were filled and sealed as described in Example 1.

### Example 3

A study compared the ability of rats of two species to obtain access to normal grain when offered as 25 grams of grain within cardboard tubes with edible paper end plugs or within cellulose sachets. Rats were simultaneously offered a cellulose sachet and a cardboard tube containing an identical quantity of the same wheat grain which did not contain poison.

Rats were live-captured, using swing door traps, from infested cane field in North Queensland and acclimatised in individual cages for one week before commencing tests. During acclimatisation, rats were offered ad libitum cane stems and sunflower seeds and water. Any rat that did not accept the offered food and maintain or gain liveweight during the acclimatisation period was deleted from the study. Details of age, weights and sex were kept for all animals, although the data indicated no effect of age, sex or live weight on the results of any of the pen tests. Group size was either 13 or 26 rats for most studies. Data is therefore pooled for all animals and the results are considered representative of the range of animals to be experienced in the field.

Using individually caged M burtoni and R sordidus rats it was shown that, over a four day test period, neither species readily opened tubular cardboard bait stations. Most tubular cardboard bait containers remained unopened for several days (see Table 1). The rats failed to quickly open the tubes regardless of whether alternative food of sunflower seeds and sugar cane was offered, i.e. the rats did not readily open the tubes even when hungry as a result of the removal of alternative food. Furthermore, the addition of supposed attractants, such as linseed oil, did not increase the rate at which either species of rat was able to open the tubes to obtain access to the contents. The study suggested that the sealed tubular bait stations did not provide an effective presentation of bait for either rodent species in the field.

In marked contrast both species of rat readily opened cellulose sachets containing wheat grain (Table 1). Rats readily opened sachets regardless of whether the sachets were offered in the presence or absence of abundant alternative food consisting of sunflower seeds and freshly cut mature cane stalk segments.

TABLE 1
Proportion of rats opening cardboard tube or cellulose sachet bait
containers at various times after exposure to two species of rat

| Type of bait | | | | | | | |
|---|---|---|---|---|---|---|---|
| container | Rat species | 0 hours | 12 hrs | 24 hrs | 48 hours | 72 hrs | 96 hrs |
| Cardboard | R sordidus | 0% | 0% | 15.4% | 15.4% | 23.1% | Not |
| tube | | | | | | | tested |
| | M burtoni | 0% | 12.5% | 12.5% | 25% | 25% | 37.5% |
| Cellulose | R sordidus | 0% | 100% | 100% | 100% | 100% | 100% |
| sachet | | | | | | | |
| | M burtoni | 0% | 100% | 100% | 100% | 100% | 100% |

### Example 4

Some species of rat exhibit preferences for certain types of food that be used for the basis of a bait preparation. A simple test was conducted to confirm whether R sordidus rats would open cellulose sachets containing different types of bait material.

Cellulose sachets of the general types described in example 1 were prepared containing 25 grams of wheat or 25 grams of oats were offered simultaneously to 13 individually penned R sordidus and the opening of sachets within 12 hours overnight was recorded. Neither of the grain contents contained poison. Twelve of thirteen test rats opened at least one of the sachets within 12 hrs. Six rats opened both within the observation period. There did not appear to be a greater preference for opening sachets of wheat vs. oats with a total of nine sachets of each type opened (Table 2).

TABLE 2
Number of rats opening cellulose sachets containing wheat or oats
under pen conditions when both sachets were offered simultaneously
and in the presence of abundant alternative food of sunflower seeds
and freshly cut mature cane stalk segments

| | | Wheat sachets | | |
|---|---|---|---|---|
| | Wheat | plus + oat | Oat sachets | No sachets |
| Sachet contents | sachets only | sachets | only | opened |
| Number of rats | 3 | 6 | 3 | 1 |
| opening sachets | | | | |
| within 12 hours | | | | |

The ability of the cellulose sachets to be opened by rats in the field was confirmed in cane crops in northern Queensland, using sachets filled with un-poisoned grain. Both oat and wheat grain were tested. It was found that high proportions of the sachets containing either grain were opened within the first 96 hrs after placement within a mature sugar cane crop (Table 3).

TABLE 3
Ability of rats to open cellulose sachets (% opened) containing
un-poisoned wheat or oat grain at various times after placement
under field conditions in mature cane crops infested with both
R sordidus and M burtoni rat species.

| Type of grain | | | | |
|---|---|---|---|---|
| in sachet | 24 hours | 48 hours | 72 hours | 96 hours |
| Wheat | 56% | 57% | 67% | 78% |
| Oats | 67% | 93% | 93% | 100% |

### Example 5

Individually caged rats (R sordidus species) were offered a choice of three sachets prepared using different membrane materials and each sachet containing 25 grams of wheat grain containing no poison. The sachets were constructed from: a) cellulose membrane, b) high density polypropylene lined paper, and c) low density polypropylene lined paper.

It was noted that rats gained ready access to the cellulose membrane sachets (Table 4). Moreover, often when the cellulose sachets where opened, the damage and exposure of the bait contents was greater than when the polypropylene lined paper sachets were opened. Rats appeared able to tear large holes in the cellulose membrane sachets whereas they ofen only nibbled small holes in the polypropylene lined paper sachets.

TABLE 4
% of sachets containing unpoisoned wheat grain opened within 12
hours of exposure to individually caged R sordidus rats

| | % of sachets opened |
|---|---|
| Sachet type | within 12 hours |
| Cellulose | 85% |
| Low density polypropylene lined paper | 69% |
| High density polypropylene lined paper | 46% |

### Example 6

a) Individually penned rats maintained in wire mesh cages in a shaded open air pen facility with excellent ventilation were each offered a choice of three different sachets each containing 25 grams of wheat bait containing 2.5% w/w zinc phosphide. 13 rats of each species were tested (6 in the presence of alternative feed and 7 without alternative feed). Since there was no effect of the presence of alternative feed on the effectiveness of the sachets, the data is pooled for all rats.

Within 24 hrs of offering R sordidus the ZP bait sachets 12 of the 13 rats had died and by 48 hours all rats had died. The death rate of M burtoni rats was slower, with 38% (5/13 rats) still alive after 48 hrs (Table 5). This preliminary experiment demonstrated that bait sachets could be used to provide lethal doses of zinc phosphide to rats of both species and suggested slightly higher efficacy for R sordidus than M burtoni. However, since several of the rats had opened more than one type of sachet before succumbing, a second experiment was conducted to confirm the efficacy of the cellulose sachet membrane as a delivery package for ZP wheat bait.

TABLE 5
Survival (% of 13 rats surviving) at various times after exposure of
individually penned rats of two species to a choice of three sachet
types each containing wheat grain poisoned with 2.5% w/w zinc
phosphide

| Rat species | 0 hours | 24 hours | 48 hours |
|---|---|---|---|
| R sordidus | 100% | 7.7% | 0% |
| M burtoni | 100% | 53.8% | 38.5% |

b) In the second test, 13 rats of each species were individually caged and offered a single cellulose sachet containing 25 g of wheat bait containing 2.5% w/w zinc phosphide. The results confirmed that both species were killed by the cellulose sachets containing ZP wheat bait with only 7.7% of R sordidus and 15.4% of M burtoni alive at 1.20 hrs post exposure to the sachets (Table 6).

TABLE 6

| Rat species | 0 days | 0.5 days | 1 day | 2 days | 3 days | 4 days | 5 days |
|---|---|---|---|---|---|---|---|
| R sordidus | 100% | 31.8% | 31.8% | 23.1% | 23.1% | 15.4% | 7.7% |
| M burtoni | 100% | 78.6% | 64.3% | 42.9% | 21.4% | 21.4% | 14.3% |

The majority of R sordidus rats were killed in the first night after exposure to the sachets, whereas the M burtoni rats were killed more gradually over an extended period. In all cases the amount of bait consumed was low (but could not be determined with precision). The behaviour of the M burtoni rats indicated that most consumed some bait within two days of placement, but that they did not always die immediately. Only one rat ate a sub-lethal dose and failed to revisit the bait while another single rat did not open the bait sachet during the 96 hr observation period. Thus initial expectations of bait aversion following sub-lethal exposure were not confirmed and M burtoni continued to consume bait from the cellulose sachet within hours of sub-lethal exposure.

### Example 7

Field trials in heavily infested areas confirmed that rats readily find and open the sachets in the field. Following application of the sachets to the infested cane field dead rats were found on the ground and in the entrances to burrows within 12 hours of baiting both paddocks and winch row areas.

At the sites where the trials were conducted, the rat density was very high (40-60% trap success in ratoon cane) and rapid re-infestation of the small-scale test areas was experienced due to the unstable (mobile) rat populations after recent harvest and the use of irrigation. The importance of neighbouring properties supporting each other in rat control to deplete rats from a wide area was evident.

Because all rats that were captured before treatment were tagged it was possible to estimate the effectiveness of the bait in addressing the original rat population by assessing the number of tagged rats that are recaptured. There was also evidence for a large reduction in the proportion of active burrows in the treated areas. This was assessed by spreading talc powder around the entrance to the burrow and examining the next morning for signs of disturbance that indicates that at least one rat is still entering or leaving the burrow. The reduction of active burrows to as low as 20.5% of pre-treatment levels, suggests that in a high proportion of cases, all rats residing within individual burrows had been destroyed. This is consistent with observations of some rats taking sachets back to their burrows, which may target bait directly to nests.

### Example 8

In order to confirm that cellulose sachets containing poisoned grain were effective in the control of rats under large-scale field conditions the sachets were tested for their effectiveness in controlling rats in two situations. The test sites represented the use of the sachets to control rats in localised areas or if dispersed throughout a crop. Cellulose sachets were placed either in three rows 10 meters apart and at spacings within rows of 10 meters between sachets along known sites of rat infestations (eg along the grassy sections under the travel lines of irrigation equipment (“furrow sites”) and throughout rat infested sugarcane crops on a grid spacing of 10 meters (“Paddock sites”). In both cases the density of bait material within the treated areas was 100 sachets per hectare. In these studies the baits contained 10 grams of grain bait containing 2.5% w/w zinc phosphide so that the total amount of bait material used per hectare was one kilogram. Effectiveness of the treatment was assessed by measuring the proportion of rats that survived after four days.

Rat survival was measured by a capture/recapture method. First rats were live trapped within the test area prior to treatment for three consecutive nights, marking those captured with tags and then releasing them. Treatment was applied to the test areas and the live trapping of rats repeated for three consecutive nights was repeated commencing one week after treatment The process was repeated on four furrow sites and separately on four paddock sites. Similar plots to the test sites were also trapped at the same times but did not receive poison bait sachets (“control sites”). There were two control furrow sites and two control paddock sites. Measurement of tapping outcomes on the control sites allowed for the determination of natural changes in the recovery of tagged rats. Between 20 to 50 traps were used each night at each location and traps were placed either along the furrow sites at 10 meter intervals or on a 10 m×10 m grid within the central portion of paddock sites. This is standard procedure in this type of study, where the recovery is not always 100% between observation periods. By adjusting the results of the treatment sites by the mean natural change in the control sites, the true effect of treatment is determined.

When cellulose sachets containing 10 grams per sachet of grain bait containing zinc phosphide were placed in the test areas for one week there was a large reduction in the proportion of known tagged rats present in the area before treatment that could be recovered after treatment compared with untreated control sites (Table 7). After adjustment for natural declines in rat recovery in control plots the mean effect of treatment was an 88.9% reduction in rat numbers in furrow sites and an 80.1% reduction of rat numbers in paddock sites.

TABLE 7
Effect of field application of cellulose sachets containing poison bait
within rat infested areas for one week on the recovery of tagged rats (expressed as
100% capture pre-treatment and percent recapture after treatment)

| | | | | | | | Mean |
|---|---|---|---|---|---|---|---|
| Site | Control a | Control b | Test 1 | Test 2 | Test 3 | Test 4 | test |
| Furrow Pre-baiting | 100 | 100 | 100 | 100 | 100 | 100 | 100 |
| Furrow post baiting | 67 | 50 | 20 | 7 | 0 | 0 | 6.75 |
| Paddock Pre baiting | 100 | 100 | 100 | 100 | 100 | 100 | 100 |
| Paddock post baiting | 48 | 45 | 15 | 12 | 6 | 4 | 9.25 |

### Example 9

A commercially available cellulose membrane film having a density of approximately 27 grains per square meter and thickness of approximately 44 microns was irradiated at 30 kilogray using a Cobalt 60 source of gamma radiation. Sections of the sheet 25 mm in diameter were sealed as barrier between pure water on one side and a container of anhydrous silica gel on the other side of the membrane. The rate of transport of water vapour or water through the treated membrane was determined by measuring the rate of increase of weight in the silica gel as it absorbed water drawn through the cellulose membrane. Replicated tests showed that the rate of transfer of water was increased more than two fold as a result of the irradiation of the membrane.

TABLE 8
Permeability of 491 mm² areas of cellulose membrane in contact
with air or water as measured by the milligrams of water absorbed into
silica gel placed on one side of the membrane when water is placed on
the other side (mean of duplicate or triplicate determinations).

| | Time of exposure to water | | | | |
|---|---|---|---|---|---|
| | 1 day | 2 days | 3 days | 4 days | 7 days |
| Normal cellulose | 64.4 | 263.5 | 429.5 | 638.5 | 1198 |
| Cellulose exposed to | 481.9 | 956.3 | 1286 | 1672 | 2894 |
| 30 kgray of gamma | | | | | |
| irradiation | | | | | |

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

Those skilled in the art will appreciate that the invention described herein is susceptible to variations and modifications other than those specifically described. It is to be understood that the invention includes all such variations and modifications which fall within the spirit and scope. The invention also includes all of the steps, features, compositions and compounds referred to or indicated in this specification, individually or collectively, and any and all combinations of any two or more of said steps or features.

1. A package comprising an enclosure containing bait, said enclosure being formed by heat sealing a cellulose or modified cellulose film.

2. A package according to claim 1 wherein the bait comprises a palatable and edible carrier in association with an active agent which affects the physiology of a target pest.

3. A package according to claim 2 wherein the active agent is selected from the group consisting of hormones, hormone antagonists, vaccines, metal phosphides, anticoagulants and toxic chemicals.

4. A package according to claim 2 or claim 3 wherein the palatable and edible carrier is selected from the group consisting of cereal products, seed products, fruit or nut products, dairy products and pelleted or granular food products, or mixtures thereof.

5. A package according to claim 1 wherein the bait includes an attractant.

6. A package according to claim 1 wherein the enclosure is formed from a modified cellulose film.

7. A package according to claim 6 wherein the cellulose is modified by gamma radiation.

8. A package according to claim 1 which includes printing on the cellulose or modified cellulose film.

9. A package according to claim 8 in which the printing is adapted to camouflage the bait from non-target animals and birds.

10. A package according to claim 9 in which the cellulose film includes a window through which the bait can be seen by a target pest.

11. A package according to claim 1 comprising 1 to 100 grams of bait.

12. A package according to claim 1 in which the bait comprises cracked or whole cereal grains, or pellets which have been treated with zinc phosphide.

13. A method for delivering a bait to an area exposed to the environment which method comprises dispersing throughout said area packages comprising an enclosure containing a bait, said enclosure being formed by heat sealing a cellulose or modified cellulose film.

14. A method according to claim 13 wherein the packages are provided in a dispenser, bait station or container which restricts access to the packages by non-target animals or people while allowing access by the target animal.

15. A method according to claim 13 wherein the area exposed to the environment is a sugar cane crop.

16. A package according to claim 13 wherein said packages are packages as claimed in claim 2.

17. (canceled)

18. (canceled)

19. (canceled)

20. A method for delivering a rodent bait to a cane field comprising dispersing throughout cellulose or modified cellulose sachets containing grain treated with zinc phosphide.
